(19) United States
(12) Patent Application Publication
(10) Pub. No.: US 2024/0086770 A1
(43) Pub. Date: Mar. 14, 2024

(54) SENSOR MEASUREMENT ANOMALY DETECTION

(71) Applicant: Robert Bosch GmbH, Stuttgart (DE)

(72) Inventors: Karim Said Mahmoud Barsim, Stuttgart (DE); Mohamed Amine BEN SALEM, Leonberg (DE)

(21) Appl. No.: 18/465,369

(22) Filed: Sep. 12, 2023

(30) Foreign Application Priority Data
Sep. 13, 2022 (DE) 10 2022 209 542.1

(51) Int. Cl. G06N 20/00

(52) U.S. Cl. CPC G06N 20/00

(57) ABSTRACT

A computer-implemented method of detecting anomalies in sensor measurements of a physical quantity. Measurement data is obtained including multiple sensor measurements of the physical quantity. Respective weights are determined for respective sensor measurements by maximizing a discrepancy between the measurement data and a mixture distribution obtained by reweighting the sensor measurements according to the weights. The respective weights are output as indicators of outlier likelihoods for the respective sensor measurements.

### CROSS REFERENCE

The present application claims the benefit under 35 U.S.C. § 119 of German Patent Application No. DE 10 2022 209 542.1 filed on Sep. 13, 2022, which is expressly incorporated herein by reference in its entirety.

### FIELD

The present invention relates to a method of detecting anomalies in sensor measurements of a physical quantity, and to a corresponding system. The present invention further relates to a computer-readable medium.

### BACKGROUND INFORMATION

Mining genuine mechanisms underlying the complex data generation process in real-world systems is a fundamental step in promoting interpretability of, and thus trust in, data-driven models. In particular, to building trust in machine learning models, it is desired to extend such models beyond their current limits of learning associational patterns and correlations. In particular, when applying machine learning to real-life control tasks, models need to interact with their physical surroundings, taking action to change or improve their environment, or to query them about hypothetical scenarios for example to predict the effect of a control action to be taken. In such settings, interpretability is particularly important.

However, most machine learning models being used in practice today work effectively as a black-box, which constitutes significant barriers to their wide-scale adoption, in particular in safety-critical domains. Accordingly, it is desirable to measure in a physical system the strength of cause-effect relationships, as opposed to purely statistical associations: so-called causal interference. The information about the underlying data generation process that such causal interference provides, has various applications for example for anomaly detection or root cause analysis.

In S. Shimizu et al., “A Linear Non-Gaussian Acyclic Model for Causal Discovery”, Journal of Machine Learning Research 7 (2006), a technique is presented to determine the causal structure of continuous-valued data using independent component analysis. The technique works under the assumptions that (a) the data generating process is linear, (b) there are no unobserved confounders, and (c) disturbance variables have non-Gaussian distributions of non-zero variances. In particular, the technique is limited in the type of sensor data that it is applicable to.

Another problem that occurs when understanding data of real-world systems, is that of anomaly detection. Here, the problem is to determine, given a set of sensor data values, which of these values are likely to be outliers. Also in this setting, various techniques are available that impose restrictions on the type of sensor data that is used as input.

### SUMMARY

It would be desirable to provide improved techniques to deal with sensor measurements, that are applicable to many different types of sensor data. In particular, it would be desirable to provide versatile anomaly detection techniques that can work for many different types of sensor data, and to provide versatile techniques for causal inference, e.g., to mine causal relations from a wide range of sensor data types.

In accordance with a first aspect of the present invention, a computer-implemented method and a corresponding system are provided for detecting. In accordance with an aspect of the present invention, a computer-readable medium is described.

Various measures discussed herein relate to the analysis of measurement data, comprising multiple sensor measurements of a physical quantity. In principle, many different kinds of physical quantities are supported. For example, the physical quantity can be a real-valued physical quantity, such as pressure or temperature. Interestingly, it is also possible to use physical quantities that are not represented by a single real value, e.g., binary or other categorical values; complex-valued values; and/or physical quantities represented by multiple sub-values, e.g., multiple numbers, such as a direction, a directional velocity, etc. In particular, the physical quantity can be image data, timeseries data, or a textual representation of a measurement of a physical quantity. In many cases, the physical quantity can be a physical quantity relating to the control of a computer-controlled physical system, e.g., a robot, a manufacturing machine, etc. For example, the physical quantity can represent a measurement of the environment with which the computer-controlled system interacts, or of a physical parameter of the computer-controlled system itself. By analysing such data, the controlling of the system can be improved, as illustrated by various examples.

Anomaly detection may be applied to such measurement data. Generally, anomaly detection may refer to the identification of rare measurements which deviate significantly from the majority of the data. This is also referred to as outlier detection. Identification may refer to selecting a subset of data items and/or indicating a degree of deviation for respective data items.

In this setting, the inventors have developed an anomaly detection technique that is based on comparing probability distributions. Namely, the technique uses a mixture distribution that is obtained by reweighting respective sensor measurements according to respective weights. The inventors realized that, generally speaking, the more weight is assigned to the outliers of the dataset, the bigger the discrepancy between this mixture distribution and the original dataset is expected to be. Here, the discrepancy can be a kernel-based discrepancy measure, such as in particular a maximum mean discrepancy. Accordingly, the inventors envisaged to determine the set of weights for the mixture distribution such that the discrepancy is maximized; and to output the respective weights as indicators of outlier likelihoods for the respective sensor measurements.

Interestingly, by phrasing outlier detection in terms of discrepancies between probability distributions of sensor data, an outlier detection may be obtained that works for many different types of sensor data. No specific form of sensor data needs to be assumed in order for the anomaly detection to work, e.g., the sensor data does not need to be numeric and can for example be categoric instead. Also no specific distribution for the sensor data needs to be assumed. For example, when using a kernel-based discrepancy measure such as the maximum mean discrepancy, the technique may use a kernel function that is defined on the sensor data, e.g., may make black-box use of the kernel function, with little to no further configuration or assumptions being needed. Accordingly, a widely applicable anomaly detection technique is provided that requires little manual configuration.

An important application of the provided anomaly detection technique is in causal inference, namely, in mining from measurements a causality indicator that indicates a causal effect of a first physical quantity on a second physical quantity. In particular, the provided techniques allow identifying the causal structure of a bivariate system from a single observational setting. This application uses the principle of independent causal mechanisms (ICM). Considering the probability distributions of pairs of measurements of the first and second physical quantity, the described anomaly detection may operate on the marginal distribution of the first physical quantity. By reweighting the sensor measurements of the first physical quantity to maximize their discrepancy from the original sensor measurements, as discussed, effectively two settings may be constructed, in which the marginal distributions of the physical quantity have non-negligible variations. According to the ICM principle, such variations are expected to have minimal impact on the effect generation mechanism.

The inventors realized that, as a consequence, a quantification of the impact of these variations on the conditionals, may be used to derive a causality indicator. Namely, two machine learnable models may be trained, both to predict the second physical quantity from the first quantity. Interestingly, however, the first machine learnable model may be trained based on the measurement data, whereas the second machine learnable model may be trained based on the reweighted sensor measurements. In this case, as the inventors realized, the model disagreement between these two models may be used as an indicator of the causal effect of the first physical quantity on the second physical quantity. Namely, the larger the model disagreement, e.g., the larger the difference in output of the models for a set of test inputs according to a difference measure, the less likely there is to be a causal effect of the first physical quantity on the second physical quantity. In other words, hypothesizing that the underlying causal structure for physical quantities x,y is x→y, the causal inference may be based on introducing artificial variations to the marginal distribution pₓ by reweighting; and then quantifying the impact of these variations on the conditional p_{y|x}. According to the ICM postulate, variations on pₓ are expected to have minimal impact on the conditional p_{y|x} in the genuine causal direction, so that the impact on the conditional, as measured by model (dis-)agreement, provides a causality indicator.

This application of the described anomaly detector for causal inference is particularly advantageous for a number of reasons. As discussed above, the anomaly detection works for a wide range of sensor data. This important advantage carries over to the causal inference technique as well. By being based on discrepancies between distributions; machine learning models; and model disagreement, for example using kernel-based scores, only mild assumptions are imposed on the sensor data both of the first and of the second physical quantity, thus giving the advantage of applicability for a wide range of applications. The techniques also generally work regardless of the functional form of the causal relation or the data distribution, as long as the ICM principle applies. The provided techniques can also work in bivariate systems in contrast to other conventional systems that allow causal discovery but use conditional splitting based on further quantities. More generally, the provided techniques can reduce the number of restrictions imposed on the cause-effect identification problem to be solved, in terms of functional, distributional constraints, and data type restrictions in particular. Experimentally, the provided techniques were found to provide good performance compared to the state of the art, in addition to being generic with respect to data types, and robust with respect to choice of model class and the learning capacity thereof.

In particular, the described techniques according to the present invention allow to exploit well the learning power of data-driven models to measure the genuine causal structure between physical quantities. In some existing causal inference techniques, machine learnable models are used differently, in such a way that the end result is sensitive to model choice and learning capacity. For example, some conventional approaches rely on the assumed simplicity of the functional relationship in the causal direction, making it possible to identify this relationship with a model class of limited-capacity. In this case, the higher the model capacity, the less identifiable a causal structure. Interestingly, this is not the case when applying the techniques described herein, e.g., it does not need to be assumed that the causal structure can be represented by a limited-capacity model. Unlike some existing techniques, the provided techniques can be more robust to the model capacity as long as the used models are capacitive enough to learn variations of conditionals. More generally, the techniques do not rely on using a particular type of machine learnable model, allowing to choose whichever model is best applicable to a given set of sensor measurements.

It is noted that, when determining a causality indicator based on model disagreement as described herein, it is not absolutely needed to train the second model on reweighted sensor measurements. More generally, according to an example embodiment of the present invention, the model may be trained on a modified probability distribution of the sensor measurement that has been determined to have a discrepancy from the original probability distribution, such that the marginal distribution of the physical quantity has non-negligible variations and the ICM principle applies.

The causal inference techniques provided herein have various practical uses. In particular, the causal inference may be used in data-driven control of a computer-controlled system such as a robot or manufacturing plant. In such a case, the system may be controlled to affect a physical quantity, based on determining that this physical quantity has a causal effect on a further physical quantity. For example, a data-driven controller may use one or more causality indicators determined as described herein in order to determine which physical quantity to affect in order to reach a pre-specified operational range. This can be fully automatic, e.g., a user may only need to specify a range for one or more physical quantities, with the data-driven controller configured to automatically determine, using the provided causal inference techniques, which physical quantities to affect to reach this range. As another example of an automated use in the context of a computer-controlled system, it is possible to raise an alert, for example to a human user, if a determined weight of the anomaly detection exceeds a threshold, thus directly applying the anomaly detection in the computer-controlled system.

However, also manual use of the determined causality indicators is possible, e.g., use of causality indicators, or a causal effect direction derived from them, can considerably reduce efforts, e.g., in terms of measurement and storage, in design-of-experiments by indicating relevant quantities to vary in the system under consideration.

Optionally, the causal inference is used for an automated root cause analysis of a failure of a computer-controlled system, in particular a physical system such as a robot or manufacturing plant. The root cause analysis may be based on determining that the physical quantity has a causal effect on the further physical quantity. For example, in a production line, the root cause analysis (e.g., a fault tree analysis, or the like) can be used to automatically determine a specific stage or station of the production line to which the failure (e.g., a system failure, or a failed quality test) can be traced. Here, the root cause analysis may use a relevance of respective production stages to aspects of the system/quality test as indicated by causality indicators or causality indicator comparisons determined as described. The root cause analysis may output an alert indicating the physical quantity identified as root cause, e.g., when reporting the failure to a user.

Optionally, apart from determining a causality indicator for causal effect of a first physical quantity on a second physical quantity, also a further causality indicator may be determined indicating a causal effect of the second physical quantity on the first quantity. By comparing the two causality indicators, it may be determined, from a single observational setting, which one causes the other. For example, the direction corresponding to the smallest model disagreement, may be determined to be the causal direction.

Optionally, measurement data may be used involving measurements of at least three physical quantities. Among these physical quantities, two quantities may be identified as having a causal relation. For example, techniques can be used for this, e.g., as is conventional, that identify the pair of quantities without identifying the causal direction between the pair. The techniques provided herein, and in particular the comparison between causality indicators, can then be used to determine a direction of the identified causal relation. For example, an existing technique may output a set of causal relations as a Markov equivalence class, e.g., with one or more bivariate causal relationships left undirected, with the techniques provided herein being used to determine the directions of one or more of the causal relations indicated in the graph.

Optionally, the model disagreement that is used to determine a causality indicator, is determined based on a maximum mean discrepancy between predictions of the trained models. Using a maximum mean discrepancy has the advantage that it can be applied to many different types of data, e.g., it may suffice to choose a kernel function and this kernel function can moreover be the same as was used in the used anomaly detection to define the discrepancy between the sensor measurements and their mixture distribution.

Optionally, when determining the weights as part of the anomaly detection, this determination may be performed such that it constrains the weight of a sensor measurement to a maximum weight and/or the deviation from uniform to a maximum deviation. This is possible both when using the anomaly detection to determine a causality indicator and more generally. For anomaly detection, this has the advantage that it allows to explicitly determine the relative size of the anomalous subset. When used for causality inference, adding such constraints is beneficial because it allows for more stable training of proxy models, thereby reducing sensitivity to the amount of presented training data.

In particular, a constraining of the maximum weight may be used to determine the causality indicator, namely, based on a trend in the model disagreement for varying values of the maximum weight. Interestingly, by using this trend to determine the causality indicator, a causality indicator may be obtained that is less dependent on the data space of the sensor measurements. In particular, it allows to better compare causality indicators between sensor measurements that have different data spaces.

Optionally, when using the maximum mean discrepancy to determine the weights of the anomaly detection, the quantity to be maximized may be based on a squared maximum mean discrepancy. Interestingly, this optimization problem can be implemented efficiently with convex optimization under a semi-definite relaxation.

Optionally, the weights may be determined by maximizing the discrepancy with respect to only a selected subset of samples, selected from the measurement data. This may improve overall efficiency since otherwise, the number of samples may become a performance bottleneck. In particular, when applying the anomaly detection in causal inference, it was found worthwhile to only use a selected subset of samples. Training of models can still be performed on the full measurement dataset, since the training in many cases has better scaling characteristics than the weight determination.

According to an example embodiment of the present invention, a system may be provided that comprises the anomaly detection system as described herein, and the computer-controlled system to whose measurements the anomaly detection system is applied. E.g., the system may be a manufacturing plant, a robot, etc.

It will be appreciated by those skilled in the art that two or more of the above-mentioned embodiments, implementations, and/or optional aspects of the present invention may be combined in any way deemed useful. Modifications and variations of any system and/or any computer readable medium, which correspond to the described modifications and variations of a corresponding computer-implemented method, can be carried out by a person skilled in the art on the basis of the present description.

### BRIEF DESCRIPTION OF THE DRAWINGS

These and other aspects of the present invention will be apparent from and elucidated further with reference to the example embodiments described by way of example in the following description and with reference to the figures.

FIG. 1 shows a system for detecting anomalies, according to an example embodiment of the present invention.

FIG. 2 shows a detailed example of root cause analysis, according to the present inventon.

FIG. 3A shows a detailed example of detecting anomalies in sensor data, according to the present invention.

FIG. 3B shows a detailed example of sensor data with detected anomalies, according to the present invention.

FIG. 4 shows a detailed example of determining a causality in sensor data, according to the present invention.

FIG. 5 shows a detailed example of determined causality indicators, according to the present invention.

FIG. 6 shows a computer-implemented method of detecting anomalies, according of an example embodiment of the present invention.

FIG. 7 shows a computer-readable medium comprising data, according to an example embodiment of the present invention.

It should be noted that the figures are purely diagrammatic and not drawn to scale. In the figures, elements which correspond to elements already described may have the same reference numerals.

### DETAILED DESCRIPTION OF EXAMPLE EMBODIMENTS

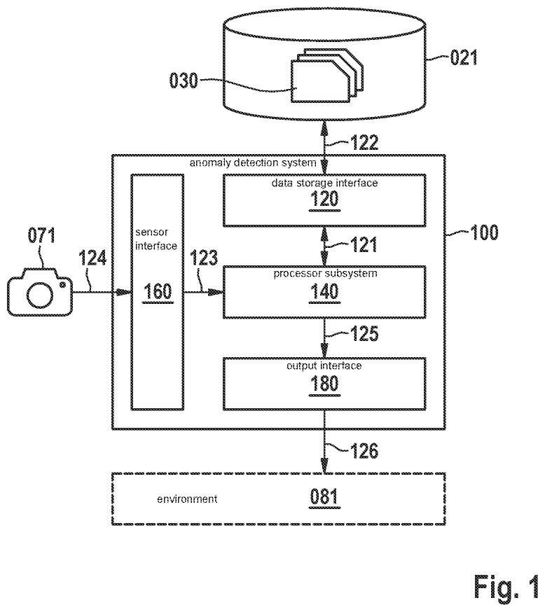

FIG. 1 shows an anomaly detection system 100. System 100 may be for detecting anomalies in sensor measurements of a physical quantity.

The system 100 may comprise a data interface 120. The data interface may be for accessing weights for sensor measurements and/or various other data as described herein. For example, as also illustrated in FIG. 1, the data interface may be constituted by a data storage interface 120 which may access the data from a data storage 021. For example, the data storage interface 120 may be a memory interface or a persistent storage interface, e.g., a hard disk or an SSD interface, but also a personal, local or wide area network interface such as a Bluetooth, Zigbee or Wi-Fi interface or an ethernet or fibreoptic interface. The data storage 021 may be an internal data storage of the system 100, such as a hard drive or SSD, but also an external data storage, e.g., a network-accessible data storage. In some embodiments, the data may each be accessed from a different data storage, e.g., via a different subsystem of the data storage interface 120. Each subsystem may be of a type as is described above for the data storage interface 120.

The system 100 may further comprise a processor subsystem 140 which may be configured to, during operation of the system 100, determining respective weights for respective sensor measurements of the physical quantity. Processor subsystem 140 may be configured to determine the weights by maximizing a discrepancy between the measurement data and a mixture distribution obtained by reweighting the sensor measurements according to the weights. Processor subsystem 140 may be configured to output the respective weights as indicators of outlier likelihoods for the respective sensor measurements. For example, the weights may be output to a user or to a module that performs additional processing based on the weights, e.g., determining a causality indicator.

The system 100 may further comprise a sensor interface 160 for accessing measurement data 124 comprising multiple sensor measurements of one or more physical quantities, in particular of the physical quantity of which anomalies are detected; of a further physical quantity on which a causal effect may be established; and/or of a set of physical quantities among which a causal relation and its direction may be determined. The measurement data 124 may be of one or more sensors 071 in an environment 081 of the system 100. The sensor(s) may be arranged in environment 081 but may also be arranged remotely from the environment 081, for example if the quantity(s) can be measured remotely. The sensor(s) 071 can but do not need to be part of the system 100. The sensor(s) 071 may have any suitable form, such as an image sensor, a lidar sensor, a radar sensor, a pressure sensor, a contain temperature sensor, etc. In some embodiments, the sensor data 124 may comprise sensor measurements of different physical quantities in that it may be obtained from two or more different sensors sensing different physical quantities.

The sensor data interface 160 may have any suitable form corresponding in type to the type of sensor, including but not limited to a low-level communication interface, e.g., based on I2C or SPI data communication, or a data storage interface of a type as described above for the data interface 120.

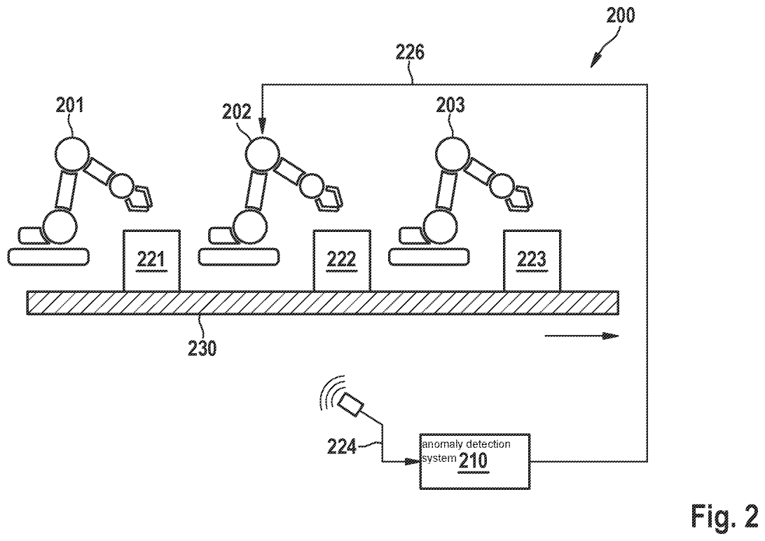

In various embodiments, the system 100 may comprise an output interface 180 for outputting data based on the respective weights. For example, as illustrated in the figure, the output interface may be constituted by an actuator interface 180 for providing control data 126 to one or more actuators (not shown) in the environment 082. Such control data 126 may be generated by the processor subsystem 140 to control the actuator based on determined weights, and in particular, based on a determined causality indicator. For example, system 100 may be a data-driven control system for controlling a physical system. The actuator may be part of system 100. For example, the actuator may be an electric, hydraulic, pneumatic, thermal, magnetic and/or mechanical actuator. Specific yet non-limiting examples include electrical motors, electroactive polymers, hydraulic cylinders, piezoelectric actuators, pneumatic actuators, servomechanisms, solenoids, stepper motors, etc. Such type of control is also described with reference to FIG. 2.

In other embodiments (not shown in FIG. 1), the system 100 may comprise an output interface to a rendering device, such as a display, a light source, a loudspeaker, a vibration motor, etc., which may be used to generate a sensory perceptible output signal which may be generated based on the determined weights. The sensory perceptible output signal may be directly indicative of the weights, but may also represent a derived sensory perceptible output signal, e.g., for use in guidance, navigation or other type of control of the physical system. For example, the output signal can be an alert that is raised if a determined weight exceeds a threshold. The output interface can also be constituted by the data interface 120, with said interface being in these embodiments an input/output (‘IO’) interface, via which the determined weights, or an output derived from the weights, may be stored in the data storage 021. In some embodiments, the output interface may be separate from the data storage interface 120, but may in general be of a type as described above for the data storage interface 120.

In general, each system described in this specification, including but not limited to the system 100 of FIG. 1, may be embodied as, or in, a single device or apparatus, such as a workstation or a server. The device may be an embedded device. The device or apparatus may comprise one or more microprocessors which execute appropriate software. For example, the processor subsystem of the respective system may be embodied by a single Central Processing Unit (CPU), but also by a combination or system of such CPUs and/or other types of processing units. The software may have been downloaded and/or stored in a corresponding memory, e.g., a volatile memory such as RAM or a non-volatile memory such as Flash. Alternatively, the processor subsystem of the respective system may be implemented in the device or apparatus in the form of programmable logic, e.g., as a Field-Programmable Gate Array (FPGA). In general, each functional unit of the respective system may be implemented in the form of a circuit. The respective system may also be implemented in a distributed manner, e.g., involving different devices or apparatuses, such as distributed local or cloud-based servers. In some embodiments, the system 100 may be part of vehicle, robot or similar physical entity, and/or may be represent a control system configured to control the physical entity.

FIG. 2 shows a computer-controlled system 200 comprising an anomaly detection system 210, e.g., based on anomaly detection system 100 of FIG. 1.

In this example, the computer-controlled system is a production line. The figure shows a product being manufactured in multiple respective stages, e.g., corresponding to respective stations of the production line. As an illustrative example, the figure shows three stations 201-203 of the production line at which three instances 221-223 are processed of the product to be manufactured. One or more respective stations may be implemented by respective manufacturing robots, for example.

The figure further shows the anomaly detection system 210 obtaining measurement data 224 of the production line. The measurement data may comprise measurements of one or more physical quantities. For example, the physical quantities may comprise physical quantities of the products 221-223, physical input or output quantities of the stations 201-203, and/or physical quantities of the environment in which the system 200 operates. The data may be measured by the manufacturing robots 201-203 and/or externally from the manufacturing robots, e.g., by one or more external sensors.

Based on the measurement data, the anomaly detection system may determine weights, indicating outlier likelihoods of corresponding sensor measurements. The determined weights may be used in system 200 in various ways.

In particular, as illustrated in the figure, the weights may be used to derive actuator data 226 for affecting the operation of computer-controlled system, in this example the production line.

In particular, the weights may be used to determine a causality indicator that indicates a causal effect of a first physical quantity of the measurement data 224 on a second physical quantity of the measurement data 224. For example, the causality indicator may be compared to a causality indicator in the other direction to determine the direction of the causal relation between the quantities. Interestingly, determining that the first physical quantity has a causal effect on the second physical quantity can enable system 200 to control the system 200 to affect the first physical quantity. In particular, system 210 may be a data-driven control system, e.g., system 210 may automatically determine an intervention based on the identification of the first physical quantity, e.g., in order to reach a pre-specified operational range.

In particular, the causality indicator can be used in a root cause analysis of a failure, in this case of the production line. For example, the failure can be a system failure, or a failure in a quality test of the production line. By performing a fault tree analysis or other type of root cause analysis, the failure may be traced back to one or more particular stages or stations of the production line. For example, the stages may include a painting and/or a welding stage. Accordingly, the provided techniques may be used to identify a relevance of respective stages to aspects of the failure, e.g., aspects of the system or quality test. As illustrated in the figure, having traced the failure to a station, station 202 in this example, the system 210 may be configured to determine actuator data 226 to affect the operation of the identified station 202 aiming to remedy the failure.

Such a root cause analysis can in particular be based on a causal graph. A causal graph may comprise multiple nodes representing respective factors potentially affecting a result, e.g., a result of the quality test. For example, the number of nodes of the graph can be at least 3, at least 5, or at least 10. Edges may represent causal relations between the factors represented by the nodes.

Various conventional techniques can be used in determining a causal graph. Existing techniques may be used to determine a graph that has one or more undirected edges, optionally in combination with one or more directed edges. For example, existing techniques may be used to determine a graph that indicates that a causal relation exists between a pair of nodes, but not in which direction. Such a graph is also known as a Markov equivalence class. Example of algorithms that can be used, are the Peter-Clark (PC) algorithm and the Fast Causal Inference (FCI) algorithm. See for example Thuc Duy Le et al., “A fast PC algorithm for high dimensional causal discovery with multi-core PCs”, arXiv:1502.02454 (incorporated herein by reference), and T S Verma et al., “Equivalence and Synthesis of Causal Models”, proceedings UAI'90 (incorporated herein by reference). For example, according to existing techniques, a partially undirected graph of factors may be obtained, and updated by iteratively removing and/or orienting edges. The techniques described herein can for example be used in combination with such techniques to provide the orientation of an edge, corresponding to a determined causal relation.

A causal graph may be used to automatically determine an effective intervention to the computer-controlled system 200. In particular, the intervention may be determined by performing a counter-factual analysis on a failure case to identify one or more factors that contributed to the failure, e.g., based on changing these factors and performing recourse, e.g., checking that replaying the scenario eliminates that failure. Concretely, in manufacturing plant 200, produced parts 221-223 may undergo a set of one or more quality tests at the end of the production line. If a part 221-223 fails a certain quality test, the counter-factual analysis may be used to pinpoint the station 202 responsible for that failure. The determined intervention may be output, e.g., to a user, or to a control system for automatic application.

In particular, the counter-factual analysis may be based on determining an estimate of a posterior distribution on one or more unobserved (e.g., environmental) factors from one or more observed quantities (e.g. tests and/or stational measurements). By using a causal graph, such an estimate may be produced in a computationally more efficient way. Given the posterior, the scenario may be re-simulated assuming a modified behaviour for one or more stations identified to have causal effect(s), and an effect of the intervention may be determined, e.g., by checking if the intervention causes the part to now pass the test that it previously failed.

In root cause analysis, it is particularly beneficial to be able to use non-real-valued data for one or more of the sensor measurements that are being analysed. For example, one or more of the sensor measurements for which a causal graph is determined, may be categorical or binary. For example, a sensor measurement may represent an outcome of a quality test, e.g., represented categorically as traffic-lights flags or the like, or represented in binary as a pass/fail flag for a manufactured part. One or more of the sensor measurements can also be image data, e.g., of an image captured after a certain step of the production process. For example, a sensor measurement can represent a pixel-level light or colour intensity.

Apart from root cause analysis, the anomaly detection and/or causal analysis described herein also has various other applications in the context of computer-controlled systems. In particular, the anomaly detection may be used to raise an alert, for example to a human user or to another system, if a determined weight exceeds a threshold. Accordingly, the discussed anomaly detection may be used to determine more accurate alerts and/or to determine alerts for kinds of sensor that other anomaly detection techniques are not well suited to, e.g., non-floating-point sensor data. Another application is to output a determined causality indicator, or data derived from it, for use in design-of-experiments, by providing information about relevant quantities to vary in the system. More generally, by providing information about the true data generation process in the causal direction, the provided techniques can empower a domain expert with the correct and relevant signals to control the behaviour of a system, or to identify the genuine cause of an undesired behaviour e.g. system failure.

Although the techniques are demonstrated in this figure with reference to a manufacturing system, this is not a limitation. The provided techniques can be applied to a wide range of computer-controlled systems, e.g., the system 210 can be a vehicle control system, a controller of a domestic appliance or a power tool; a robotics control system, a manufacturing control system, or a building control system. Also the used sensor measurements 224 can be measured by various types of sensor. For example, the sensor measurements 224 can comprise measurements by an image sensor, e.g., video data, radar data, LiDAR data, ultrasonic data, motion data, or thermal image data, and/or by an audio sensor. Kernel functions that operate on such types of measurements are conventional.

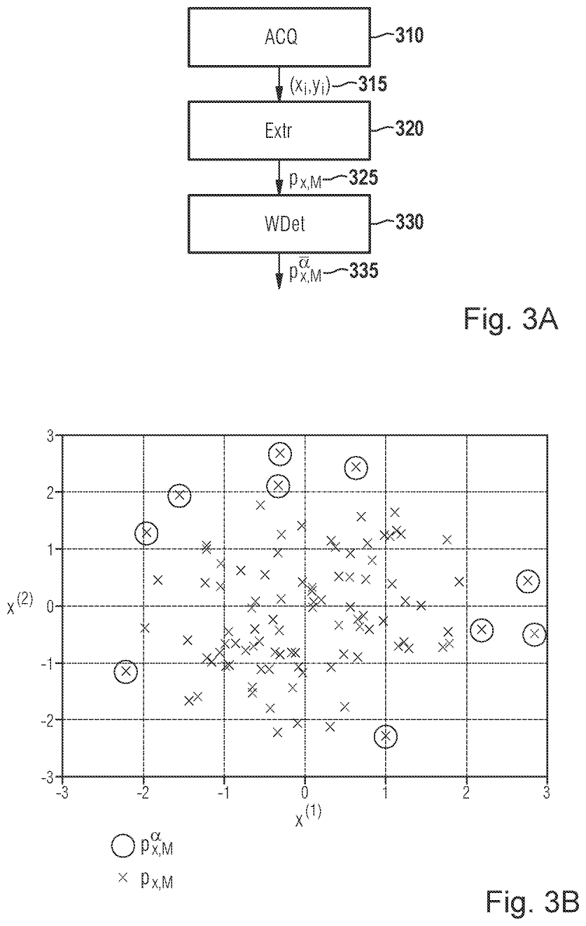

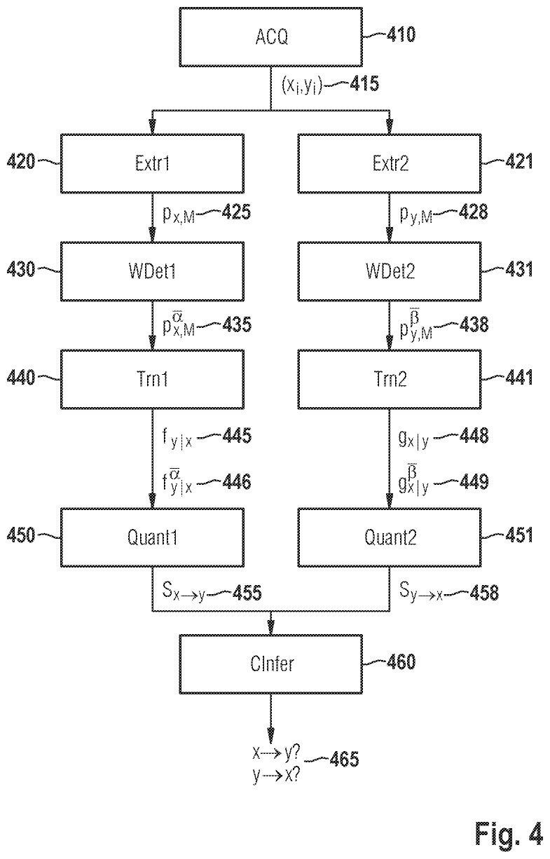

FIG. 3a shows a detailed, yet non-limiting, example of detecting anomalies in sensor measurements. The anomaly detection may be used for determining a causality indicator as discussed e.g. with respect to FIG. 4, but can also be performed for other purposes, e.g., to raise alert in case an anomaly is found.

Shown in the figure is an acquisition operation ACQ, 310, in which measurement data 315 may be obtained comprising multiple sensor measurements of a physical quantity. The measurement data may be denoted as a N-sample set {(xᵢ, yᵢ)}ᵢ₌₁^{N}. As also discussed elsewhere, various types of sensor measurement are possible, e.g., digital images, e.g. video, radar, LiDAR, ultrasonic, motion, or thermal images; audio signals; or other types of data on which a kernel can be defined. The acquisition may comprise a pre-processing of the measurements; for example, the dataset may be standardized using an outlier-robust scaling operation such as sklearn's RobustScaler.

Generally, various types of sensor measurement are possible. The sensor measurements can be real-valued or not, e.g., the sensor measurements can be categorical values (e.g., obtained by quantization or indexing), or binary values. A sensor measurement can also be vector of multiple values, e.g., at least two or at least three values. For example, the vector values can be real-valued, e.g., a directional velocity or a gradient, but the vector can also contain one or more non-real-valued values. In particular, respective sensor measurements may represent respective time series, e.g., a time times may be considered as a single multi-variate object, e.g., on which a timeseries kernel such as a global alignment kernel can be defined.

As an optional next step, an extraction step Extr, 320, may be performed in which a subset 325 of samples is determined from the measurement data, for which weights are determined. This set is also referred to as the coreset p_{x,M}. Other steps described herein, such as training machine learning models and/or determining a model disagreement, can still be performed on the full measurement data. By determining weights for only a subset of samples, efficiency of the weight determining step may be greatly improved, at the expense of not learning a weight for each of the samples.

In particular, various implementations of the weight determining operation described herein, may scale quadratically in the number of weights to be determined. By performing extraction Extr, the weighted distribution p_{x,N}^{α} described herein may be restricted to a smaller number of samples M<<N drawn at least partly at random from the original dataset. Accordingly, a M-sample subset p_{x,M} and a corresponding weighted version [symbol] thereof may be obtained. The size of the reference empirical distribution p_{x,N} may not affect the dimensionality of the optimization problem of determining the weights and can thus grow as needed, e.g., within Gram matrix computational limits. Multiple weights are determined; for example, regardless of whether an extraction is performed, the number of sensor measurements for which a weight is determined may be at most or at least 100, at most or at least 1000, or at most or at least 10000, for example. The original dataset can be larger, e.g., can comprise at least 100000 or at least 1000000 measurements.

How to select the subset and whether or not this is beneficial, depends on the application. For example, when determining a causality indicator, performing extraction Extr can be beneficial since in this case the quality of the determined indicator may not be greatly diminished but performance is improved. In this case, the subset may be determined at least in part at random. When performing anomaly detection per se, e.g., to raise an alert, it is possible for example to use extraction operation Extr to select a subset that contains the most recent measurements as well as a random selection of earlier measurements; or the anomaly detection can be based on the full history; or it can be based on the most recent sensor measurements, e.g., a fixed number or from a fixed time period.

As a specific example, the coreset [symbol] _{C} may be selected in order to represent the distribution of the original set. This can be done for example based on a kernel density estimation (KDE) estimate on the values of the physical quantity. For example, a number of rare samples may be included, e.g., a fixed number of k samples, or samples with a probability lower than a certain threshold p, e.g., p=0.05. A number of samples can be randomly selected, e.g., M−k samples. This latter random selection can for example be performed multiple times, with the selected subset being selected to be representative of the dataset, e.g., having the minimal MMD to the original set. It may be noted that, for sufficiently small datasets, the above procedure may automatically result in the original set.

Further shown in the figure is a weight determining operation WDet, 330. The weight determining operation WDet may be configured to determine respective weights [symbol] for respective sensor measurements. The weights may be determined by maximizing a difference in probability distribution between the measurement data p_{x,M} and a mixture distribution obtained by reweighting the sensor measurements according to the weights. In other words, given samples {xₙ}ₙ₌₁^{N}, the weight vector α may be determined in such a way that it renders the mixture distribution p_{x,N}^{α} maximally distinct from p_{x,N} according to a discrepancy measure D( [symbol] ). The weights may be output as indicators of outlier likelihoods for the respective sensor measurements, for example, in the form of outputting the mixture distribution 335 that incorporates the weights.

By using the mixture distribution, variations may be introduced to the marginal distributions. As discussed, by using such variations, potential dependencies can be revealed between the marginal distribution and the corresponding conditional distribution. It is noted that this does not necessarily retain similar dynamics to an intervention.

In particular, the mixture distribution may be defined as a weighted Dirac mixture distribution. More specifically, given [symbol] ₓ with an unknown marginal pₓ, the original sensor measurements may be identified with the empirical distribution on these samples, defined as the uniform mixture of the Dirac delta distributions δₓ_{ₙ} defined on the respective samples, e.g.:

p_{x,N}(x)=1/NΣₙ₌₁^{N}δ(x−xₙ)=1/NΣₙ₌₁^{N}δₓ_{ₙ}.

This can be seen as a probability density function with a corresponding discrete empirical cumulative distribution function F_{N}(x) (eCDF) defined on the sample set as F_{N}(x)=1/NΣₙ₌₁^{N}1ₓ_{ₙ}_{≤x} where 1_{(⋅)} is the indicator function and the inequality is entry-wise.

Based on this definition of the measurement data, the mixture distribution obtained of the sensor measurements according to the weights may be obtained as a generalization of the empirical distribution, in particular as a weighed mixture of constituent Dirac distributions δₓ_{ₙ}, denote by p_{x,N}^{α}, e.g.:

p_{x,N}^{α}(x)=Σₙ₌₁^{N}αₙδₓ_{ₙ}

where α=[αₙ]ₙ₌₁^{N}∈[0, 1]^{N×1} is a non-negative weight vector satisfying 1^{T}α=1 where 1 is the all-ones vector.

The weights may be obtained by maximizing the discrepancy between the sensor measurements and the mixture distribution. This discrepancy can be a kernel-based discrepancy, defined with respect to a positive definite kernel function

$${k}_{𝕏} : {𝕏}^{2} \to ℝ .$$

Once defined, the kernel [symbol] can lift any constraint on the data space [symbol] . Specifically, the discrepancy can be based on the maximum mean discrepancy (MMD). The MMD is advantageous among other reasons for its analytical tractability.

Given a kernel k, the MMD can be expressed as norm in a reproducing kernel Hilbert space (RKHS) [symbol] between the kernel embeddings of the distributions:

$${MMD}_{k}^{2} ( p , q ) = {‖ {μ}_{p} - {μ}_{q} ‖}_{ℋ}^{2}$$

where μₚ and μ_{q} are the mean embeddings of p and q, respectively, in the Hilbert space [symbol] through the feature mapping k(x,⋅). Various kernels can be used depending on the data at hand; a good default choice is the squared exponential kernel k(x,\tilde{x})=exp(−∥x−\tilde{x}∥²/2σ²), where σ is a length-scale. For example, the length-scale may be selected using a maximum likelihood estimate, e.g., using a kernel density estimator on a k-fold cross validation scheme, e.g., with k=5.

In particular, the discrepancy can be based on a squared maximum mean discrepancy. An advantage of the squared MMD is that it has an analytically tractable empirical estimator of a quadratic form given by:

$${MMD}_{k}^{2} ( p , q ) ≃ \frac{1}{{N}^{2}} {\sum }_{i , j = 1}^{N} k ( {x}_{i ,} {x}_{j} ) - \frac{2}{NM} {\sum }_{i , j = 1}^{N , M} k ( {x}_{i ,} {y}_{j} ) + \frac{1}{{M}^{2}} {\sum }_{i , j = 1}^{M} k ( {y}_{i} , {y}_{j} ) ,$$

where {xᵢ}ᵢ₌₁^{N} and {yᵢ}ᵢ₌₁^{M} are finite sample sets drawn from p and q, respectively.

In particular, the squared MMD discrepancy between the measurement data, in other words the empirical distribution p_{x,N}; and the mixture distribution, in other words the weighted version of the empirical distribution p_{x,N}^{α}, may be calculated as:

$${MMD}_{k}^{2} ( {p}_{x , N}^{α} , {p}_{x , N} ) ≃ {α}^{T} {K}_{xx} α - \frac{2}{N} {α}^{T} {K}_{xx} 1 + \frac{1}{{N}^{2}} {1}^{T} {K}_{xx} 1$$

where Kₓₓ=[k(xᵢ, xⱼ)]_{i,j=1}^{N} is the Gram matrix of the kernel k on the sample set [symbol] .

Based on the squared MMD as a discrepancy measure, the task to maximize the discrepancy between the measurement data and the mixture distribution, may be stated mathematically as:

$${maximize}_{α} {MMD}_{{k}_{𝕏}}^{2} ( {p}_{x , N}^{α} , {p}_{x , N} )$$

$$subject to {1}^{T} α = 1 α ⩾ 0 ( entrywise )$$

$$α ⩾ 0 ( entrywise )$$

It may be noted that, in spite of convexity of the objective (since MMD is jointly convex in both arguments) and linearity of both constraints, the optimization problem as phrased above remains non-convex. This is due the fact that the convex objective is being maximized rather than minimized which renders the objective a concave function in the standard form of a convex optimization problem.

Interestingly, the optimization problem may still be solved efficiently by applying a semidefinite relaxation. In particular, noting that the closed-form estimator of the squared MMD has a quadratic form in the optimization variable α, the semidefinite relaxation may be applied as a two-step procedure. First, the optimization problem may be lifted to a higher dimensional space, e.g., by defining A=αα^{T}, which may make the objective function become linear. Then, a convex relaxation may be applied to the intractable constraints. For the above maximization problem, the following relaxation may be obtained, which is in the form of a quadratically constraint quadratic program (QCQP):

$${maximize}_{A} A \cdot ( {K}_{xx} - \frac{2}{N} {K}_{xx} 1 {1}^{T} ) + \frac{1}{{N}^{2}} {1}^{T} {K}_{xx} 1$$

$$subject to [ \begin{matrix}A & A 1 \\ {1}^{T} A & 1\end{matrix} ] ⪰ 0 ( p ositive semidefiniteness ) ;$$

$$A ⩾ 0 ( entrywise ) ;$$

$${1}^{T} A 1 = 1 ;$$

$$A = {A}^{T} ;$$

where

$${K}_{xx} = {[ {k}_{𝕏} ( x , \tilde{x} ) ]}_{x , \tilde{x} ∈ {𝒟}_{x}}$$

is the Gram matrix, and ⋅ denotes the dot-product in matrix space defined as A⋅Kₓₓ=trace(AKₓₓ). Techniques for efficiently solving QCQPs are conventional in the related art and can be applied here; see for example the software library cvxpy as described in S. Diamond et al., “CVXPY: A Python-embedded modeling language for convex optimization”, Journal of Machine Learning Research, 2016.

The weights may be determined based on the solution to the semidefinite relaxation. In the above formulation, the solution A^{SDR} may be guaranteed to be an optimal solution to the original maximization problem, e.g., A^{SDR}≡A* if the condition A*=α*α*^{T} is satisfied, in particular if A^{SDR} is rank one. This may be the case in particular if A^{SDR} is a feasible solution to the original optimization problem. The distribution weights may be recovered as α*=A*1. When the rank one condition is not satisfied, the solution [symbol] obtained from the SDR formulation can still be used since it provides a lower bound on the optimal value of the original formulation that in practice turns out to be a good estimate for the weighted empirical. The weight vector can be estimated based on the semidefinite relaxation for example as α≃A^{SDR}1.

From a practical perspective, it can be beneficial to introduce additional constraints into the above-discussed maximization of the discrepancy. In particular, it can be beneficial to constraining the maximum weight of a sensor measurement and/or to constrain a maximum deviation from uniform, in particular to improve training stability.

In particular, it may be noted that, when using an MMD-based discrepancy measure, attainable solutions are in many cases Dirac-like distributions in the sense that ∥α∥_{∞}˜1 where ∥⋅∥_{∞} is the supremum norm. This can be avoided by augmenting the optimization problem with further constraints such as:

∥A∥_{∞} [symbol] b_{α}

which directly constraints the maximum probability mass that is allowed on a single data point, where b_{α}∈[1/M, 1.0] is a hyper-parameter. Likewise, a maximum deviation from the uniform mixture distribution may be constrained using constraint

$${MMD}_{k}^{2} ( {p}_{\cdot , M}^{\tilde{α}} , {p}_{\cdot , M} ) ⩽ {MMD}^{2} ( {p}_{\cdot , M} , {p}_{\cdot , N} ) + {b}_{{D}^{′}}$$

where b_{D} is a slack variable. The left-hand side is a linear function of the optimization variable A, similar to above, with a different Gram matrix. Interestingly, both of the above constraints are convex and so the SDR formulation remains a convex optimization problem if augmented wither either of these constraints.

FIG. 3b shows a detailed, yet non-limiting, example of data on which an anomaly detection is applied. The figure shows an outcome of maximizing an MMD-based discrepancy using a semidefinite relaxation, as discussed with respect to FIG. 3a. The data in this example is a 2D Gaussian dataset. The true distribution is pₓ= [symbol] (0, 1) from which N=100 samples are depicted, shown by crosses in the figure. Circles around the crosses represent the weights α of the weighted distribution p_{x,100}^{α}. In this example, the provided techniques assigned substantially identical weights to the respective points. In this example, constraint b_{α}=0.1 on the maximum weight was used, and in particular, the rank-one condition discussed with respect to FIG. 3a was not satisfied in this example. Still it may be noted that the solution poses relatively high weights on rare points, thus providing successful outlier detection.

FIG. 4 shows a detailed, yet non-limiting, example of determining a causality between sensor measurements, based on an anomaly detection e.g. of FIG. 3a.

Specifically, the figure shows an acquisition operation Acq, 410, e.g., based on acquisition operation 310 of FIG. 3a. In this operation, measurement data may be obtained that comprises pairs (xᵢ, yᵢ), 415, of sensor measurements of a first and second physical quantity. From this data, a causality indicator may be determined, indicating a causal effect of the physical quantity x on the physical quantity y. The sensor measurements can be of various types as also discussed elsewhere. In particular, the respective sensor measurements can be respective time series of measurements of one or more physical quantities, in which case the causality analysis can output a summary graph as conventional in the field of causal inference, in particular for timeseries data.

The causal effect may be identified based on the Independence of Causal Mechanisms (ICM) principle. This principle postulates that the genuine data generation process decomposes into independent modules that do not inform or influence each other. Such independence is in practice less likely to hold in anti-causal decompositions. Specifically, in a bivariate causal graph x→y with a joint distribution p_{xy}, ICM may imply independence between the marginal pₓ and the conditional p_{y|x}, denoted p_{y|x}⊥pₓ. ICM may effectively induce an asymmetry in bivariate systems that can be used for causal inference.

Mathematically, let [symbol] ={(xₙ, yₙ)}ₙ₌₁^{N} denote set 415 of N i.i.d samples passively obtained, e.g. in an observational setting p_{xy}, from a bivariate system, where x∈ [symbol] and y∈ [symbol] are two random variables following the marginals pₓ and p_{y}, respectively. Let [symbol] ₓ={xₙ|(xₙ, yₙ)∈ [symbol] } denote the x-covariate view of the dataset, and likewise for [symbol] .

As shown in the figure, to perform cause-effect identification, several steps may be performed independently in the spaces for the respective physical quantities x,y, with the results being compared to determine a causal direction. In particular, causality indicators may be determined for the causal effect of x on y and for the causal effect of y on x; and the causality indicators may be compared to each other. The provided techniques may accordingly allow cause-effect inference from an observational setting for a bivariate system (x,y).

The mathematical framework on which the described techniques are based, may be defined based a number of assumptions, in particular: acyclicity; existence of a causal link (e.g. either x→y or y→x); and causal sufficiency, e.g., assuming that all relevant covariates are observed. A further assumption may be that the cause and effect spaces are identical, such that discrepancies across the spaces are comparable. Interestingly, also when these assumptions are not fully satisfied, the provided techniques were found to provide good results. This is also despite the possibility of disagreement bias for certain models that are trained with a randomization factor. Indeed, when training an identical model on identical data, still, due to the randomization factor, the trained models typically do not agree on all test cases. This disagreement bias may be countered by selecting a model in which it is less prevalent, e.g., by selecting a different kind of model than a neural network.

As illustrated in the figure, for the two physical quantities separately, subsets of samples p_{x,M}, 425; p_{y,M}, 428 may be determined in extraction operations Extr1, 420 and Extr2, 421, respectively. As discussed with respect to FIG. 3a, such extraction operations are optional but beneficial to improve computational efficiency. The subsets can be selected independently, e.g., for a given pair (xᵢ, yᵢ) of measurements, it is possible that xᵢ is selected in subset p_{x,M} but yᵢ is not selected in subset p_{y,M}, or the other way round.

$${p}_{x , M}^{\overline{α}} {p}_{y , M}^{\overline{β}} {p}_{x , M}^{\overline{α}} p ( x ) {p}_{x , N} {p}_{x , M} {p}_{y , M}^{\overline{β}} p ( y ) {p}_{y , N} {p}_{y , M} β ∈ {[ 0 , 1 ]}^{M \times 1}$$

Also for the two physical quantities separately, respective sets of weights, 435, 438 may be determined WDet1, 430, WDet2, 431, by maximizing the discrepancies between the respective measurement data and the respective mixture distributions. E.g. , 435 may be determined as a weighted Dirac mixture distribution

$${p}_{x , M}^{\overline{α}} {p}_{y , M}^{\overline{β}} {p}_{x , M}^{\overline{α}} p ( x ) {p}_{x , N} {p}_{x , M} {p}_{y , M}^{\overline{β}} p ( y ) {p}_{y , N} {p}_{y , M} β ∈ {[ 0 , 1 ]}^{M \times 1}$$

of that is maximally distinct from the set or core set, 425 based on a MMD discrepancy measure; and, 438 may be determined as a weighted

Dirac mixture distribution of that is maximally distinct from the set or core set, 428 based on the MMD discrepancy measure, with weight vector. Various options discussed with respect to FIG. 3a, e.g., the constraining of a maximum weight of a sensor measurement and/or the constraining of a maximum deviation from uniform, also apply here.

Having performed the above-mentioned anomaly detection, and having thereby determined the mixture distributions 435, 438 for the respective physical quantities, follow-up steps may quantify the impact of these artificially generated variations on the conditional distributions of the physical quantities given the other physical quantity. For example, the impact on the conditionals p_{x|y} and p_{y|x} may be quantified within the marginals p_{x,N} and p_{x,N}^{α}, and similarly from p_{y,N} to p_{y,N}^{β}, respectively. It is noted that, in order to introduce variations in the marginal distributions of the physical quantities x, y, in other words to determine modified probability distributions [symbol] , 435, [symbol] that have a discrepancy to the original probability distributions p_{x,M}, p_{y,M}, it is in principle possible to use other techniques than described operations WDet1, WDet2. The ICM principle can still be used.

The quantification may be based on training operations Trn1, 440; and Trn2, 441. In operation Trn1, corresponding to the x→y direction, a first predictive model \hat{f}_{y|x}, 445, may be trained to predict the second physical quantity y from the first physical quantity x based on the measurement data 415 (or coreset 425). A second predictive model \hat{f}_{y|x}^{α}, 446, may be trained to predict the second physical quantity y from the first physical quantity x based on the reweighted sensor measurements 435. In the opposite direction, operation Trn2 may fit predictive models ĝ_{x|y}, 448 and ĝ_{x|y}^{β}, 449 based on the measurement data 415 (or coreset 428); and based on the mixture distribution 438, respectively.

Various options are possible for the predictive models. Interestingly, the proposed techniques generally pose little restrictions on the models used. It is however desirable that the models perform similarly on their training sets. This can be achieved for instance by monitoring the training process and performing early stopping if needed; or by training an over-parametrized model to near-zero or zero training error.

To obtain an accurate causality indicator, the models may generally be selected to have sufficient capacity to represent the relation between the physical quantities x,y. For example, the number of trainable parameters of a used model may be at least 1000, at least 10000, or at least 100000. As a specific example, the predictive models can be Gaussian processes. In particular, the Exact-GP model can be used, e.g., using the mean value for the prediction of the GP model. As another example, the predictive models can be neural networks.

For training Trn1, Trn2, various techniques may be used that are conventional, e.g., training may be performed using stochastic approaches such as stochastic gradient descent, e.g., using the Adam optimizer as described in Kingma and Ba, “Adam: A Method for Stochastic Optimization” (available at https://arxiv.org/abs/1412.6980 and incorporated herein by reference). As is conventional, such optimization methods may be heuristic and/or arrive at a local optimum. In order to fit the predictive model 446, 449 on a weighted empirical distribution 435, 438, for example, the corresponding weights can be used as sample weights in the loss function of the model. An example of training on a weighted distribution in the Gaussian process setting is described in J. Wen et al., “Weighted Gaussian Process for estimating treatment effect”, proceedings NIPS 2018 (incorporated herein by reference). In the case of neural networks, the training on a weighted distribution can for example be performed as described in M. Steininger et al., “Density-based weighting for imbalanced regression”, Machine Learning, 110(8):2187-2211, 2021 (incorporated herein by reference).

Based on the trained models 445-446, 448-449, causal effect indicators 455, 458 for the directions x→y and y→x, respectively, may be determined in quantification operations Quant1, 450; and Quant2, 451. A causality indicator 455 (or 458) may indicate a causal effect of the physical quantity x (or y) on the further physical quantity y (or x) based on a model disagreement of the trained models 445, 446 (or 448, 449).

In particular, ICM may postulate that, if x→y is the true causal direction of the data generation process, then the impact of the introduced marginal variations on the g models 448, 449 are likely to more apparent than on the f models 445, 446. This impact may be quantified via model disagreement on a (possibly unlabelled) set. In particular, the model disagreement 455 may be based on a maximum mean discrepancy between predictions of the trained models 445, 446 on a common set:

$${S}_{x \to y} = {MMD}_{{k}_{𝕐}}^{2} ( {\hat{f}}_{y \vert x} ( x ) , {\hat{f}}_{y \vert x}^{α} ( x ) ) .$$

Here x˜pₓ(x), for example, all samples 415 in [symbol] ₓ can be used, or a random subset thereof. Model disagreement S_{y→x}, 458 in the other direction can be determined similarly.

As discussed, a causality indicator 455 (or 458) may be output per se without the causality indicator in the other direction necessarily also being determined. For example, the value S_{x→y} or S_{y→x} itself can be output, or it can be thresholded, for example.

In other embodiments, having determined the causality indicators 455, 458, they are compared in an inference operation CInfer, 460, to infer a causal direction, e.g., x→y or y→x, 465. In particular, the lower of either scores S_{x→y}, 455 and S_{y→x}, 458, may be used as an indicator of the causal direction.

In particular, the following algorithm illustrates an example implementation of the operations 430-431, 440-441, 450-451, 460 described herein:

Algorithm. Variation-based Cause-Effect Identification (VCEI)
Require: [symbol] = {(xₙ, yₙ)}ₙ₌₁^{N}, kernel function k, model class [symbol] ,
hyper-parameter b_{α}
Ensure: [symbol] = [symbol] (where x ∈ [symbol] and y ∈ [symbol] )

Determine causality indicator S_{x→y}:
solve semidefinite relaxation of discrepancy problem in [symbol] ₓ to estimate α

$${\hat{f}}_{y \vert x} ← {Train}_{ℳ} [ {p}_{xy , N} ]$$

$${\hat{f}}_{y \vert x}^{α} ← {Train}_{ℳ} [ {p}_{xy , N}^{α} ]$$

$${S}_{x \to y} ← {MMD}_{k}^{2} ( {\hat{f}}_{y \vert x} ( {p}_{x , N} ) , {\hat{f}}_{y \vert x}^{α} ( {p}_{x , n} ) )$$

Determine causality indicator S_{y→x}:
solve semidefinite relaxation of discrepancy problem in [symbol] _{y} to estimate β

$${\hat{g}}_{y \vert x} ← {Train}_{ℳ} [ {p}_{xy , N} ]$$

$${\hat{g}}_{y \vert x}^{α} ← {Train}_{ℳ} [ {p}_{xy , N}^{β} ]$$

$${S}_{y \to x} ← {MMD}_{k}^{2} ( {\hat{g}}_{x \vert y} ( {p}_{y , N} ) , {\hat{g}}_{y \vert x}^{β} ( {p}_{y , n} ) )$$

if S_{x→y}<S_{y→y} then return “x→y”
if S_{x→y}>S_{y→y} then return “y→x”

As an alternative to the above-discussed quantification operations Quant1, Quant2, it is also possible to determine a causality indicator 455, 458 based on a trend in the model disagreement, for varying values of a maximum weight that is used when determining the weights WDet1, WDet2.

Using such a trend can improve the comparability between causality indicators, in particular when comparing causality indicators in the CInfer operation. Mathematically speaking, a comparison that is based on comparing MMD values across spaces and not based on a trend, may be implicitly based on the assumption that the data spaces [symbol] ≡ [symbol] and the kernels

$${k}_{𝕏} ≡ {k}_{𝕐}$$

are comparable. Such an implicit assumption exists in many prior works as well. This assumption means that in practice, such a comparison is less accurate when the data spaces and/or kernels differ too much.

Interestingly, by using a trend, this implicit assumption can be avoided. The inventors observed that the attainable discrepancy, e.g., between p_{⋅,N}, 425 and p_{⋅,N}^{α}, 435, is largely monotonic w.r.t to the hyper-parameter b_{α} that is used to constrain the maximum weight of a sensor measurement. As a consequence, determining the weights for increasing values for b_{α} is likely to be reflected in an increasing trend of the disagreement score of the anti-causal direction. In the causal direction, however, the disagreement score is expected to remain roughly constant. Accordingly, this trend may be used to determine the causality indicators 455, 458, e.g., as linear regression coefficients or similar. The trends can for example be compared in the CInfer operation by comparing the values of the causality indicators, by performing a suitable statistical test, etc.

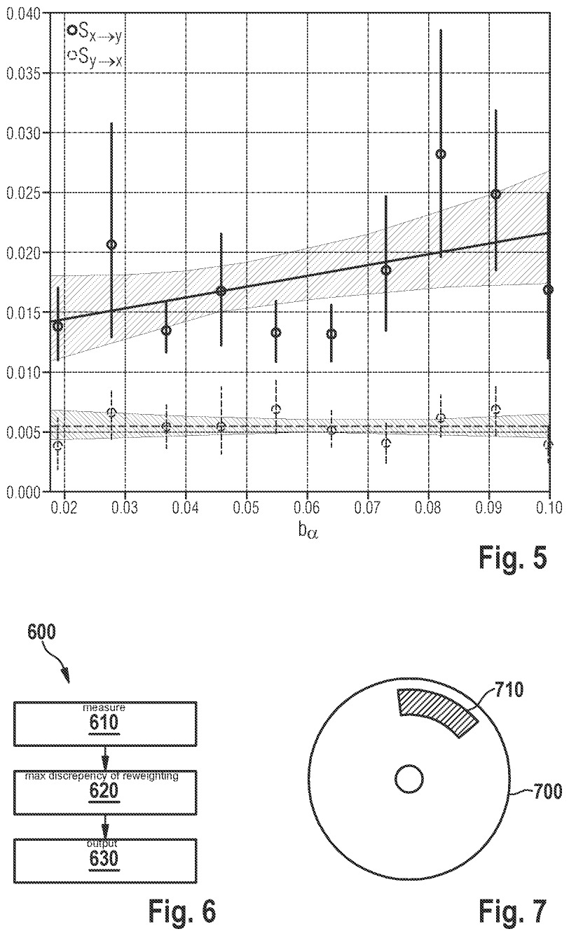

This is further illustrated with respect to FIG. 5. FIG. 5 shows a detailed, yet non-limiting, example of causality indicators determined for pairs of sensor measurements. The figure shows the application of the discussed techniques on the simulation data generated in J. Mooij et al., “Distinguishing cause from effect using observational data: methods and benchmarks”, Journal of Machine Learning Research, 2016. Specifically, in this example, the first pair of the SIM dataset was used. The true causal structure for this data is y→x. The example shows the model disagreement as described herein for the two causal directions, as a function of the maximum weight hyperparameter b_{α}.

It is observed that the model disagreement in the causal direction is consistently smaller than the model disagreement in the anti-causal direction. Accordingly, the true causal direction can be determined by comparing model disagreements. It is also observed that the model disagreement has an increasing trend in the anti-causal direction and not in the causal direction, for varying values of the maximum weight hyperparameter b_{α}. Accordingly, the true causal direction can also be determined by comparing the trends in model disagreement.

Some mathematical details are now provided of ways to determine weights using a semidefinite relaxation of the squared maximum mean discrepancy.

Generally speaking, to determine the weights, the following problem may be considered. Given a set of samples [symbol] ₓ={xₙ}ₙ₌₁^{N} from a random variable x∈ [symbol] , find the weight vector α that renders the mixture distribution p_{x,N}^{α} maximally distinct from p_{x,N} in a discrepancy measure D( [symbol] ). With the kernel-based MMD measure

$$D ≡ {MMD}_{{k}_{{𝕏}^{′}}}$$

this problem may be phrased as:

$${maximize}_{α} {MMD}_{{k}_{𝕏}}^{2} ( {p}_{x , N}^{α} , {p}_{x , N} )$$

$$subject to {1}_{N}^{T} α = 1 , α ⩾ 0 ( entrywise )$$

where 1_{N} refers to a vector of ones with dimensionality N. The quantity being optimized can be reformulated as follows:

$${MMD}_{{k}_{𝕏}}^{2} ( {p}_{x , N}^{α} , {p}_{x , N} ) = {‖ {p}_{x , N}^{α} ( x ) - {p}_{x , N} ( x ) ‖}_{ℋ}^{2} = {‖ {\sum }_{n = 1}^{N} α {δ}_{{x}_{n}} - \frac{1}{N} {\sum }_{n = 1}^{N} {δ}_{{x}_{n}} ‖}_{ℋ}^{2} = {\sum }_{n}^{N} {α}_{n} {α}_{n} ′ 〈 {δ}_{{x}_{n} ,} {δ}_{{x}_{n ′}} 〉 - \frac{2}{N} {\sum }_{n , n′ = 1}^{N} {α}_{n} 〈 {δ}_{{x}_{n} ,} {δ}_{{x}_{n ′}} 〉 + \frac{1}{{N}^{2}} {\sum }_{n , n′ = 1}^{N} 〈 {δ}_{{x}_{n} ,} {δ}_{{x}_{n ′}} 〉 {α}^{T} {K}_{xx} α - \frac{2}{N} {α}^{T} {K}_{xx} {1}_{N} + \frac{1}{{N}^{2}} {1}_{N}^{T} {K}_{xx} {1}_{N}$$

where Kₓₓ=[k(xᵢ, xⱼ)]_{i,j=1}^{N} is the Gram matrix of the kernel function

$${k}_{𝕏} : 𝕏 \times 𝕏 \to {ℝ}^{+}$$

on the sample set [symbol] ₓ. Accordingly, the optimization problem may be written as:

$${maximize}_{α} {α}^{T} {K}_{xx} α - \frac{2}{N} {α}^{T} {K}_{xx} {1}_{N} + \frac{1}{{N}^{2}}$$

$$subject to {1}_{N}^{T} {K}_{xx} {1}_{N} {1}_{N}^{T} α = 1 α ⩾ 0 ( entrywise ) ,$$

$$subject to {1}_{N}^{T} α = 1 α ⩾ 0 ( entrywise )$$

This optimization problem is not a convex optimization problem since it is a maximization of a convex function. Noting that the closed-form estimator of the squared MMD has a quadratic form in the optimization variable α, this problem can be addressed in a two-step procedure as a semidefinite relaxation (SDR). First, the problem may be lifted to a higher dimensional space by defining e.g. A=αα^{T} in which the objective function becomes linear. Then, a convex relaxation may be applied to the intractable constraints. Without affecting the solution to the problem and using the properties of the trace of a matrix, the above objective terms may be reformulated as:

α^{T}Kₓₓα=trace(α^{T}Kₓₓα)=trace(αα^{T}Kₓₓ)=trace(AKₓₓ)=A⋅Kₓₓ

and similarly for the second term:

2α^{T}Kₓₓ1_{N}=trace(α^{T}Kₓₓ1_{N})=trace(αα^{T}Kₓₓ1_{N}1_{N}^{T})=A⋅Kₓₓ1_{N}1_{N}^{T}

where ⋅ denotes the dot-product in matrix space defined as A⋅Kₓₓ=trace(AKₓₓ).

From the condition A=αα^{T}=[αᵢⱼ]_{i,j=1}^{N,N}, convex constraints may be extracted. The first is the entry-wise non-negativity αᵢⱼ=αᵢαⱼ [symbol] 0 due to the entry-wise non-negativity of α∈[0, 1]^{N}. The second is the consequence of the normalized vector 1_{N}^{T}α=1 which can be expressed in A as 1_{N}^{T}A1=1_{N}^{T}α(1_{N}^{T}α)^{T}=1. The last is the similarity of A=A^{T} by definition. Finally, the equality condition above can be relaxed to A≥αα^{T} and written in its Schur-complement form.

As a result, the following formulation can be obtained as a relaxation of the above optimization problem as a quadratically constraint quadratic program (QCQP):

$${maximize A}_{α} \cdot ( {K}_{xx} - \frac{2}{N} {K}_{xx} {1}_{N} {1}_{N}^{T} ) + \frac{1}{{N}^{2}} {1}_{N}^{T} {K}_{xx} {1}_{N}$$

$$subject to [ \begin{matrix}A & A {1}_{N} \\ {1}_{N}^{T} A & 1\end{matrix} ] ⪰ 0 ( positivesemidefiniteness )$$

$$A ⩾ 0 ( entrywise )$$

$${1}_{N}^{T} A {1}_{N} = 1$$

$$A = {A}^{T} .$$

This problem can be observed to have a convex objective (linear) with convex constraints which can be solved using existing techniques, e.g., the cvxpy software package.

Further, the following problem may be considered. Given two sets of samples {xₙ}ₙ₌₁^{N} and {\tilde{x}ₘ}ₘ₌₁^{M} from the two distributions p_{x,N} and p_{\tilde{x},M}, respectively, with the corresponding random variables x,\tilde{x}∈ [symbol] , find the weight vector \tilde{α}∈[0, 1]^{M} that renders the mixture distribution p_{x,M}^{\tilde{α}} maximally distinct from p_{x,N} w.r.t the discrepancy measure [symbol] .

This problem can be formalized as:

$${maximize}_{α} {MD}_{{k}_{𝕏}}^{2} ( {p}_{\tilde{x} , M}^{\tilde{α}} , {p}_{x , N} )$$

$$subject to {1}_{M}^{T} \tilde{α} = 1 , \tilde{α} ⩾ 0 ( entrywise )$$

As above, the objective may be reformulated as follows:

$${MMD}^{2} {k}_{𝕏} ( {p}_{\tilde{x} , M}^{\tilde{α}} , {p}_{x , N} ) = {‖ {p}_{\tilde{x} , M}^{\tilde{α}} ( \tilde{x} ) - {p}_{x , N} ( x ) ‖}_{ℋ}^{2} = {\tilde{α}}^{T} {K}_{\tilde{x} \tilde{x}} \tilde{α} - \frac{2}{N} {\tilde{α}}^{T} {K}_{\tilde{x} x} {1}_{N} + \frac{1}{{N}^{2}} {1}_{N}^{T} {K}_{xx} {1}_{N}$$

and the objective terms can be rewritten as:

\tilde{α}^{T}K_{\tilde{x}\tilde{x}}\tilde{α}=Ã⋅K_{\tilde{x}\tilde{x}}

and similarly for the second term:

\tilde{α}^{T}K_{\tilde{x}x}1_{N}=Ã⋅K_{\tilde{x}x}1_{N}1_{N}^{T}

The constraints can be modified as above. Hence, a relaxation of this optimization problem can be formulated as:

$${maximize \tilde{A}}_{α} \cdot ( {K}_{\tilde{x} \tilde{x}} - \frac{2}{N} {K}_{\tilde{x} x} {1}_{N} {1}_{N}^{T} ) + \frac{1}{{N}^{2}} {1}_{N}^{T} {K}_{xx} {1}_{N}$$

$$subject to [ \begin{matrix}\tilde{A} & \tilde{A} {1}_{N} \\ {1}_{N}^{T} \tilde{A} & 1\end{matrix} ] ⪰ 0 ( positivesemidefiniteness )$$

$$\tilde{A} ⩾ 0 ( entrywise )$$

$${1}_{N}^{T} \tilde{A} {1}_{N} = 1$$

$$\tilde{A} = {\tilde{A}}^{T}$$

which is a QCQP on the M² optimization variables in Ã=[\tilde{α}ᵢⱼ]_{i,j=1}^{M,M}.

FIG. 6 shows a block-diagram of computer-implemented method 600 of detecting anomalies in sensor measurements of a physical quantity. The method 600 may correspond to an operation of the system 100 of FIG. 1. However, this is not a limitation, in that the method 600 may also be performed using another system, apparatus or device.

The method 600 may comprise, in an operation titled “MEASURE”, obtaining 610 measurement data comprising multiple sensor measurements of the physical quantity. The method 600 may comprise, in an operation titled “MAX DISCREPANCY OF REWEIGHTING”, determining 620 respective weights for respective sensor measurements by maximizing a discrepancy between the measurement data and a mixture distribution obtained by reweighting the sensor measurements according to the weights. The method 600 may comprise, in an operation titled “OUTPUT”, outputting 630 the respective weights as indicators of outlier likelihoods for the respective sensor measurements.

It will be appreciated that, in general, the operations of method 600 of FIG. 6 may be performed in any suitable order, e.g., consecutively, simultaneously, or a combination thereof, subject to, where applicable, a particular order being necessitated, e.g., by input/output relations.

The method(s) may be implemented on a computer as a computer implemented method, as dedicated hardware, or as a combination of both. As also illustrated in FIG. 7, instructions for the computer, e.g., executable code, may be stored on a computer readable medium 700, e.g., in the form of a series 710 of machine-readable physical marks and/or as a series of elements having different electrical, e.g., magnetic, or optical properties or values. The medium 700 may be transitory or non-transitory. Examples of computer readable mediums include memory devices, optical storage devices, integrated circuits, servers, online software, etc. FIG. 7 shows an optical disc 700.

Examples, embodiments or optional features, whether indicated as non-limiting or not, are not to be understood as limiting the present invention.

It should be noted that the above-mentioned embodiments illustrate rather than limit the present invention, and that those skilled in the art will be able to design many alternative embodiments without departing from the scope of the present invention. Any reference signs placed between parentheses shall not be construed as limiting. Use of the verb “comprise” and its conjugations does not exclude the presence of elements or stages other than those stated. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The present invention may be implemented by means of hardware comprising several distinct elements, and by means of a suitably programmed computer. In a device described as including several means, several of these means may be embodied by one and the same item of hardware. The mere fact that certain measures are recited in mutually different embodiments does not indicate that a combination of these measures cannot be used to advantage.

What is claimed is:

1. A computer-implemented method of detecting anomalies in sensor measurements of a physical quantity, the method comprising the following steps:
obtaining measurement data, wherein the measurement data include multiple sensor measurements of the physical quantity;
determining respective weights for respective sensor measurements of the multiple sensor measurements by maximizing a discrepancy between the measurement data and a mixture distribution, wherein the mixture distribution is obtained by reweighting the sensor measurements according to the respective weights; and
outputting the respective weights as indicators of outlier likelihoods for the respective sensor measurements.

2. The method of claim 1, wherein the measurement data includes pairs of sensor measurements of the physical quantity and a further physical quantity, and wherein the method further comprises:
training a first machine learnable model to predict the further physical quantity from the physical quantity based on the measurement data;
training a second machine learnable model to predict the further physical quantity from the physical quantity based on the reweighted sensor measurements;
determining a causality indicator indicating a causal effect of the physical quantity on the further physical quantity, wherein the causality indicator is determined based on a model disagreement of the trained first and second machine learnable models.

3. The method of claim 2, further comprising:
determining a further causality indicator indicating a causal effect of the further physical quantity on the physical quantity; and
comparing the further causality indicator to the causality indicator.

4. The method of claim 3, wherein the measurement data include measurements of at least three physical quantities, and wherein the method further comprises:
identifying the physical quantity and the further physical quantity from among the at least three physical quantities as having a causal relation; and
using the comparison of the further causality indicator to the causality indicator to determine a direction of the identified causal relation.

5. The method of claim 2, wherein the method is for performing root cause analysis of a failure of a computer-controlled system, and wherein the root cause analysis is performed based on determining that the physical quantity has a causal effect on the further physical quantity.

6. The method of claim 2, wherein the model disagreement is determined based on a maximum mean discrepancy between predictions of the trained first and second learnable models.

7. The method of claim 2, wherein determining the respective weights includes constraining a maximum weight of a sensor measurement and/or constraining a maximum deviation from uniform.

8. The method of claim 7, wherein the causality indicator is determined based on a trend in the model disagreement for varying values of the maximum weight.

9. The method of claim 2, wherein the sensor measurements are of a computer-controlled system, and wherein the method further comprises controlling the system to affect the physical quantity based on determining that the physical quantity has a causal effect on the further physical quantity.

10. The method of claim 1, wherein the sensor measurements are of a computer-controlled system, and wherein the method further comprises raising an alert when a determined weight exceeds a threshold.

11. The method of claim 1, wherein the discrepancy is based on a maximum mean discrepancy.

12. The method of claim 11, wherein the discrepancy is based on a squared maximum mean discrepancy, and wherein the respective weights are determined by applying a semidefinite relaxation.

13. The method of claim 1, further comprising determining weights for a selected subset of samples of the measurement data.

14. An anomaly detection system configured to detect anomalies in sensor measurements of a physical quantity, the system comprising:
a sensor interface for accessing measurement data, wherein the measurement data include multiple sensor measurements of the physical quantity;
a processor subsystem configured to:
determine respective weights for respective sensor measurements by maximizing a discrepancy between the measurement data and a mixture distribution, wherein the mixture distribution is obtained by reweighting the sensor measurements according to the respective weights; and
output the respective weights as indicators of outlier likelihoods for the respective sensor measurements.

15. A non-transitory computer-readable medium on which are stored data representing instructions for detecting anomalies in sensor measurements of a physical quantity, the instructions, when executed by a processor system, causing the processor system to perform the following steps:
obtaining measurement data, wherein the measurement data include multiple sensor measurements of the physical quantity;
determining respective weights for respective sensor measurements of the multiple sensor measurements by maximizing a discrepancy between the measurement data and a mixture distribution, wherein the mixture distribution is obtained by reweighting the sensor measurements according to the respective weights; and
outputting the respective weights as indicators of outlier likelihoods for the respective sensor measurements.
